(19) United States
(12) Patent Application Publication
(10) Pub. No.: US 2007/0182162 A1
(43) Pub. Date: Aug. 9, 2007

(54) METHODS AND APPARATUS FOR ADVANCED WINDMILL DESIGN

(76) Inventor: Frank McClintic, Toms River, NJ (US)

Correspondence Address: STRAUB & POKOTYLO, 620 TINTON AVENUE, BLDG. B, 2ND FLOOR, TINTON FALLS, NJ, 07724, US

(21) Appl. No.: 11/627,847

(22) Filed: Jan. 26, 2007

Related U.S. Application Data
(63) Continuation-in-part of application No. 11/190,687, filed on Jul. 27, 2005, now Pat. No. 7,183,664.

(51) Int. Cl. F03D 9/00

(52) U.S. Cl. 290/55

(57) ABSTRACT

Methods and apparatus of improved windmill design and operation are discussed. An improved windmill assembly includes a support, a movable counterweight and a counterweight position adjuster. The windmill tower experiences oscillations, e.g., oscillations from wind variation, turbulence, varying stress levels, structural design attributes and/or balance considerations. The windmill tower is also subjected to external forces, e.g., a steady state wind pushing the tower in one direction. The windmill assembly includes at least one sensor to measure tower position, tower motion, and/or wind velocity. A computer module, as part of the windmill assembly, processes the sensor output information and uses stored modeling information to determine counterweight position such as to dampen oscillations and/or counteract steady state forces. Control signals are generated and communicated to an actuator to move the counterweight in response to the determination.

### RELATED APPLICATIONS

The present application is a continuation-in-part of pending allowed U.S. patent application Ser. No. 11/190,687, filed Jul. 27, 2005 the full content of which is hereby expressly incorporated by reference.

### FIELD OF THE INVENTION

The present invention relates to alternative energy sources, and more particularly, to methods and apparatus for advanced windmill design.

### BACKGROUND

The worldwide appetite for energy has continued to increase as more countries industrialize, and the cost of fossil fuels has also been increasing. There is increased concern with the potential effects of greenhouse gas based global warming. In addition significant safety, security, and environmental issues remain regarding the use of nuclear energy. Therefore, there is a need for improved methods and apparatus for generating energy from clean sources, e.g., wind based energy generation.

One of the limiting factors of the current generation of wind turbines is the structural ability of the supporting tower to handle the dynamic loads to which it is subjected. Due to variable wind conditions and turbulent wind conditions the loads imposed upon the structure can and, and sometimes do, cause the tower to oscillate. The oscillation and associated bending forces, unless controlled, can cause a premature failure of the structure and induce associated forces and bending loads upon the turbine blades and its support structures.

Typically, these anticipated forces and associated reactions are taken into account in the determining of the sizing of the turbines and the tower structures. The structure is typically designed to meet worst case events over a specified time interval, e.g., a fifty year cycle, as per current design regulations and criteria. This worst case design, in view of expected worst case anticipated tower oscillation, tends to limit size and power generation levels associated with a particular size structure.

It would be beneficial if the cost of a windmill assembly structure having a given energy output could be reduced and/or the amount of energy a given size windmill structure can produce could be increased. Methods and apparatus for dampening out and/or limiting tower oscillations would be beneficial. Methods and apparatus to control stress forces within the tower would also be advantageous.

### SUMMARY

Various embodiments of the present invention are directed to methods and apparatus that dynamically dampen oscillations within the structure of a windmill assembly. In some embodiments, methods and apparatus of the present invention, by dynamically dampening oscillations, e.g., oscillations experienced by a windmill support tower, limit the oscillations' effect on the structure of the windmill assembly. In various embodiments, controlled repositioning of counterweight is utilized to dampen tower oscillations. Thus, a windmill assembly incorporating an embodiment of the present invention can have reduced initial structural cost over existing designs for the same design level of rated energy output. Alternatively or in addition, a windmill assembly, incorporating an embodiment of present invention, can have increased turbine size over an existing design, for the same initial structural cost. Thus various embodiments of the present invention increase the amount of energy absorption/output per dollar spent on structure.

In addition to controlling structure oscillations, various embodiments of the present invention, also counteract forces pushing on the tower of the windmill assembly, e.g. by moving a counterweight in an optimal or advantageous position to work to counteract the forces pushing on the tower. For example, the force being counteracted may be a force due to a steady state wind, and the compensation may make the tower lean into the wind to compensate for the wind force, thus allowing the structure to operate in a higher wind than without the leaning capability.

An exemplary windmill assembly, in accordance with various embodiments of the present invention, includes: a blade assembly, a drive shaft coupled to the blade assembly, a main driveshaft housing for housing at least a portion of the drive shaft, a support tower for supporting the main drive shaft housing, a moveable counterweight, and a counterweight position adjuster for adjusting the position of the counterweight in response to a control signal. In some embodiments, the windmill assembly further includes at least one of a position sensor and a motion sensor mounted on the support tower, e.g., an inertial measurement sensor such as an accelerometer and/or gyroscope. A wind speed sensor is included in some embodiments of the windmill assembly.

In various embodiments, the windmill assembly includes a computer control module coupled to the at least one sensor and the counterweigh position adjuster, e.g., actuator module. The computer control module generates a counterweight position control signal as a function of at least one received sensor signal. For example, the computer control module can generate a counterweight position control signal to adjust the position of a movable counterweight to dampen tower oscillations detected by the at least one sensor. Alternatively, or in addition, the computer control module can generate a counterweight position control signal to adjust the position of a movable counterweight as a function of measured wind speed from the wind speed sensor, the counterweight position being adjusted to at least partially compensate for force on the support tower due to wind.

In some embodiments, the counterweight is a sliding weight moved by an actuator, e.g., either toward or away from the turbine. In some embodiments, the counterweight is a hydraulic fluid, and repositioning the counterweight includes pumping at least some fluid from one location to another location. In various embodiments, the computer module includes programs to analyze sensor outputs and determine how far and how fast to move the counterweight and in what direction to dampen a given oscillation. In some embodiments, the computer module also determines the best position of the counterweight for a given wind velocity, e.g., to compensate for a steady state wind condition, and the computer module sends commands to implement the determination. Thus, via computer control, the counterweight, in some embodiments, is positioned towards or away from the turbine to allow for increased absorption of energy from a steady state wind condition similar to a person leaning their weight into the wind so as not to be knocked over.

An exemplary method of operating a windmill assembly, in accordance with various embodiments of the present invention includes: operating at least one sensor to sense a position of a windmill support tower or motion of the windmill support tower and adjusting the position of a windmill counterweight in response to a signal from the at least one sensor. Another exemplary method of operating a windmill assembly, in accordance with various embodiments includes: operating a wind speed sensor to sense wind speed in the vicinity of the windmill support tower and adjusting the position of a windmill counterweight in response to a signal form the wind speed sensor to adjust the position of a movable counterweight to at least partially compensate for force on the support tower due to wind.

While various embodiments have been discussed in the summary above, it should be appreciated that not necessarily all embodiments include the same features and some of the features described above are not necessary but can be desirable in some embodiments. Numerous additional features, embodiments and benefits of the various embodiments are discussed in the detailed description which follows.

### BRIEF DESCRIPTION OF THE FIGURES

FIG. 1 is a drawing including an exemplary windmill assembly implemented in accordance with the present invention.

FIG. 2 is a drawing of an exemplary computer control module, included as part of the windmill assembly of FIG. 1, implemented in accordance with the present invention and using methods of the present invention.

FIG. 3 is a flowchart of an exemplary method of operating a windmill assembly in accordance with various embodiments of the present invention.

FIG. 4 is a drawing of a flowchart of an exemplary method of operating a windmill assembly in accordance with various embodiments of the present invention.

### DETAILED DESCRIPTION

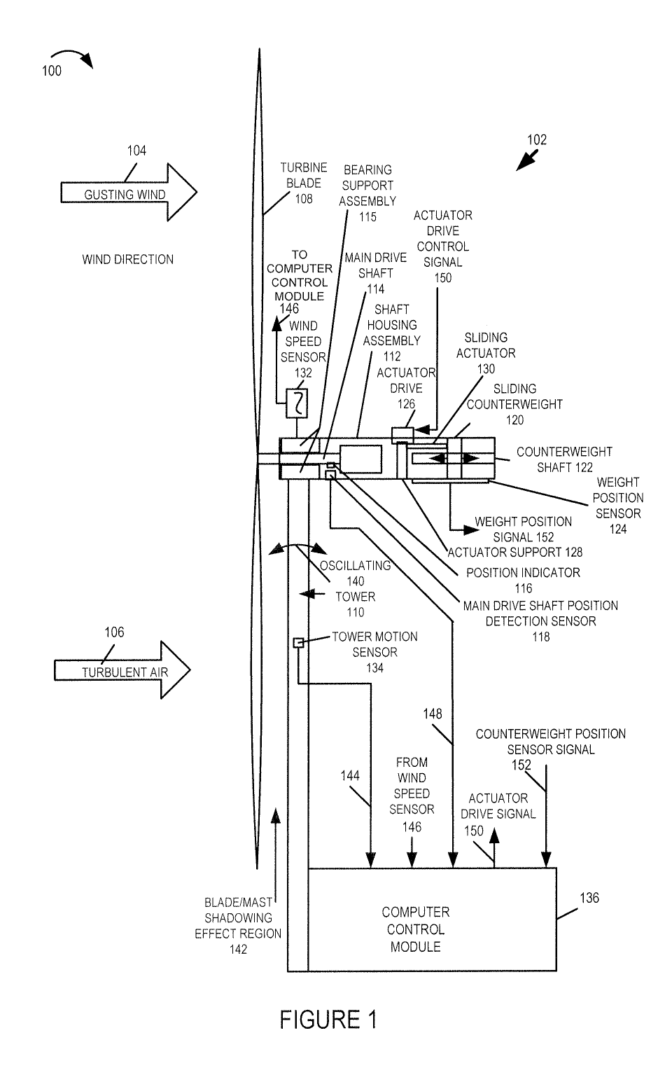

FIG. 1 is a drawing 100 illustrating an exemplary windmill assembly 102, implemented in accordance with the present invention, being subjected to gusting winds 104 and turbulent air 106. Exemplary windmill assembly 102 includes a turbine blade assembly 108, a support tower 110, a shaft housing assembly 112, a computer control module 136, a wind speed sensor 132, and a tower motion sensor 134. Shaft housing assembly 112 includes a main drive shaft, a bearing support assembly 115, a position indicator 116, a main dive shaft position detection sensor 118, a sliding counterweight 120, a sliding counterweight shaft 122, a counterweight position sensor 124, an actuator drive 126, an actuator support 128, and a sliding actuator 130. In addition, wind turbine system 102 includes a wind speed sensor 132 mounted on the shaft housing assembly 112 and a tower motion sensor 134 mounted on the tower 110. In some embodiments the actuator drive and/or counterweight position sensor are omitted and the counterweight is spring loaded by having springs or other tensioning device attached to the weight so that it tends to remain in a stationary position while the hosing may move due to wind or other turbulence. Thus, while a drive may be employed springs and/or other devices located on one or both sides of the counterweight may also be used to control the counterweight position thereby achieving an oscillation damping effect without the need for a motor to adjust the position of the counterweight used to stabilize the hosing and dampen oscillations.

The turbine blade assembly 108, over time, is subjected to winds at various velocities and turbulent air, resulting in different directional stresses at different times. The variation in wind velocity and/or turbulence level can be due to changing weather conditions. In addition, at least some of the turbulence is due a turbine blade/tower mast shadowing effect in region 142. The presence of the tower 110 causes disruption in air flow in the vicinity of the tower region as the air is forced to flow around the tower mast. The turbine blade assembly 108 is attached to main driveshaft 114 of the shaft housing assembly 112. Bearing support assembly 115 supports the shaft 114 without the housing 112. The shaft housing assembly 112 is attached to tower 110, which tends to move and oscillate as indicated by arrow 140, e.g., as a function of wind velocity and/or turbulence level. Thus, stresses are transferred into the tower 110 tending to bend and oscillate the tower 110.

Wind speed sensor 132 mounted on shaft housing assembly 112 is coupled to computer control module 136. Wind speed sensor 132 measures wind speed, e.g., the speed of gusting wind 104, and communicates the measurement information to computer control module 136, e.g., on an ongoing basis, via signal 146. Tower motion sensor 134, e.g., an inertial sensor module, detects transverse and/or angular motion of tower 110. Motion sensor output signal 144, output from tower motion sensor 134, e.g., on an ongoing basis, is received as input by computer control module 136.

Position indicator 116, is attached to main driveshaft 114, while main drive shaft position detection sensor 118 is attached to shaft housing assembly 112. Position indicator 116 operating in conjunction with main drive shaft position detection sensor 118 provides output signal 148 to computer control module 136 providing information that can be used to determine when a blade of turbine blade assembly 108 aligns with the tower 110. In addition, output signal 148 can be used to determine rotational speed of turbine blade assembly 108. In some embodiments, the position indicator 116/detection sensor 118 pair is a magnetic field type device, e.g., a Hall effect sensor. In other embodiments, the position indicator 116/detection sensor 118 pair is an optical type device, e.g., an LED or laser based optical detector module. In still other embodiments, the position indicator 116/detection sensor 118 pair is an electro-mechanical device, e.g., a lobe or lobes on shaft 114 activating a switch.

Sliding counterweight 120 can be controllably moved along counterweight shaft 122 in shaft housing assembly 112. Weight position sensor 124 detects the current position of counterweight 120 and sends counterweight position sensor signal 152 to computer control module 152.

Computer control module 136 processes the received sensor information signals 144, 146, 148 and 152, and generates actuator drive signal 150 which is communicated to actuator drive 126. The actuator drive 126 is, e.g., a mechanical or hydraulic motor. Sliding actuator 130, which is supported by actuator support 128, is controllable moved by the actuator drive 126 in response to received actuator drive control signal 150. Controlled motion of sliding actuator 130 causes controlled motion of sliding counterweight 120. In accordance with the present invention, the placement of and/of motion of the sliding counterweight 120 is controlled such as to reduce oscillations and/or motion of tower 110 and/or reduce stresses between the shaft housing assembly and tower 110.

In some embodiments, position indicator 116/detection sensor 118 and/or weight position sensor 124 are not included. For example, disturbances due to the blade/mast shadowing effect may be determined indirectly through processing of tower motion sensor measurements, and position indicator 116/main drive shaft position detection sensor 118 may be omitted. As another example, the actuator drive 126, sliding actuator 130, and sliding counterweight may have a predetermined known controllable range and weight position sensor is not needed. As still another example, the control loop used for moving the countershaft weight 120 is not concerned with the precise location of the weight 120, but rather drives the weight 120 along the shaft 122 such as to minimize tower 110 oscillations. In some embodiments, load, e.g., resistance due to power generation, on the main drive shaft 114 is measured and used as an additional input to computer control module 136.

In some embodiments, the counterweight is a hydraulic fluid, and a computer control signal controls the pumping of at least some fluid from one location to another to move counterweight. In some embodiments, the counterweight is a multi-part counterweight. In some such embodiments, one part of the counterweight is moved in response to a wind velocity sensor detection signal and another part of the counterweight is moved in response to a tower motion or position detection sensor indication.

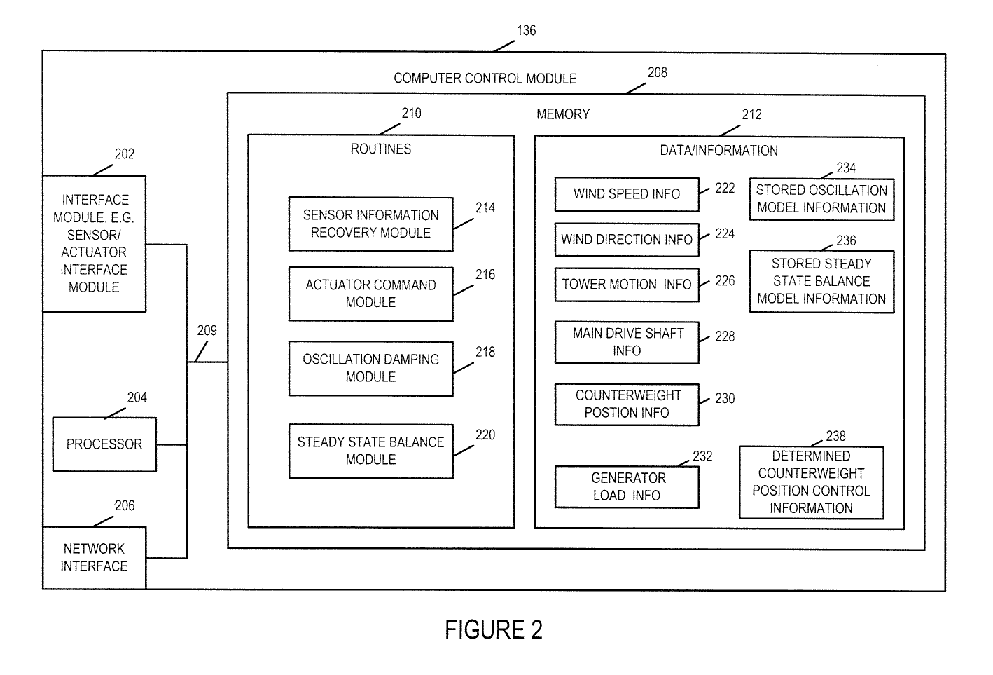

FIG. 2 is a drawing of an exemplary computer control module 136 implemented in accordance with the present invention and using methods of the present invention. Exemplary computer control module 136 includes an interface module 202, a processor 204, a network interface 206, and a memory 208 coupled together via bus 209 over which the various elements interchange data and information. Memory 208 includes routines 210 and data/information 212. The processor 204, e.g., a CPU, executes the routines of 210 and uses the data/information 212 in memory 208 to control the operation of the computer control module 136 and windmill assembly 102 and implement methods of the present invention.

Interface module 202, e.g., a sensor/actuator interface module, interface to and receives signals from various sensors, e.g., tower motion sensor signal 144, wind speed sensor signal 146, main drive shaft position sensor signal 148, and/or counterweight position sensor signal 152. Interface module 202 also interfaces to the counterweight actuator drive 126 and sends actuator drive signal 150 to the actuator.

Network interface 206 couples the computer control module 136 to other network nodes, e.g., a central control node controlling a plurality of wind turbines in the same local vicinity, and/or to the Internet. In some embodiments, at least some of the sensor input information used by computer control module 136 is from sensors located at other sites and/or at least some of the sensor information is communicated via network interface 206. For example, a wind direction sensor may be located at a nearby site and correspond to a plurality of wind turbine systems in the same local vicinity and its information may be communicated via the Internet and network interface 206.

Routines 210 include a sensor information recovery module 214, an actuator command module 216, an oscillation damping module 218, and a steady state balance module 220. Data/information 212 includes wind speed information 222, wind direction information 224, tower motion information 226, main drive shaft information 228, counterweight position information 230, generator load information 232, stored oscillation model information 234, stored steady state balance model information 236 and determined counterweight position control information 238.

Sensor information recovery module 214 processes signals from various sensors, e.g., tower motion sensor signal, tower position sensor signal, wind speed sensor, counterweight position sensor, shaft position sensor, etc. Oscillating damping module 218, uses data/information 212 including tower motion information 226 and stored oscillation model information 234 to determine damping adjustments, e.g., determine counterweight positioning control to respond to tower motion sensor detected oscillations. Steady state balance module 220 uses data/information 212 including wind speed information 222 and stored steady state balance model information 236 to determine counterweight balance positioning to respond to steady state or relatively slow time varying conditions, e.g., determine a counterweight position to at least partially compensate for force on the support tower due to wind, e.g., a steady state wind level.

Actuator command module 216 uses determinations of oscillation damping module 218 and/or steady state balance module 220, e.g., information 228, to generate actuator control signals used to reposition the counterweight. Feedback information such as counterweight position information 230 is also utilized by actuator command module 216.

Wind speed information 222 includes information from a wind sensor. Wind direction information 224 includes information from a wind direction sensor. Tower motion information 226 includes information from a tower motion sensor and/or tower position sensor. Main drive shaft information 228 includes information from a drive shaft sensor, e.g., shaft position information and/or shaft rate information. Counterweight position information 230 includes countershaft weight sensor information. Generator load information 232 includes information from a sensor measuring output generator load. Determined counterweight position control information 238 includes information determined by oscillation damping module 218 and/or steady state balance module 220.

Stored oscillation model information 234 includes information relating anticipated detectable oscillation levels to counterweight repositioning information, e.g., for achieving compensation. Stored steady model information 234 includes information relating anticipated detectable wind speed levels to counterweight repositioning information, e.g., for achieving compensation. In some embodiments, the stored oscillation model information 234 and/or stored steady state balance model information 236 includes an initial predetermined baseline model. In some embodiments, as the windmill assembly operates, the stored models 234 and/or 236 are refined, e.g., with the computer control module 136 performing learning operations to customize model parameters to the particular windmill structure, set of operating conditions, and/or sensors available.

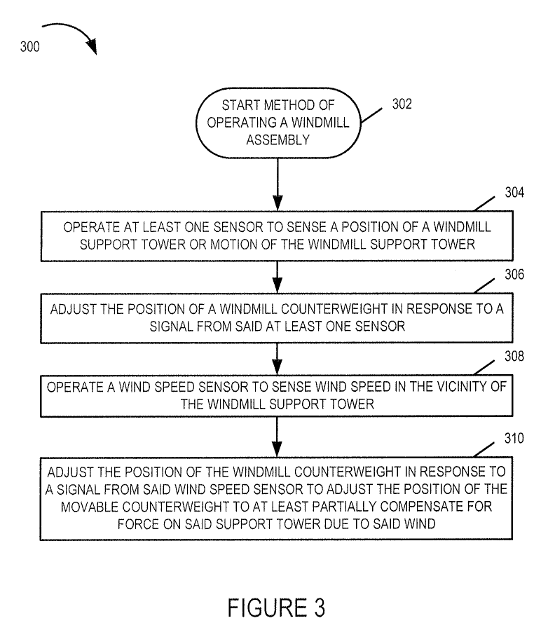

FIG. 3 is a flowchart of an exemplary method of operating a windmill assembly in accordance with various embodiments of the present invention. The windmill assembly may be exemplary windmill assembly 102 of FIG. 1. Operation starts in step 302, where the windmill system is initialized. Operation proceeds from step 302 to step 304. In step 304, the windmill assembly operates at least one sensor to sense a position of a windmill support tower or motion of the windmill support tower. Operation proceeds from step 304 to step 306. In step 306, the windmill assembly adjusts the position of a windmill counterweight in response to a signal from said at least one sensor. In some embodiments adjusting the position of the windmill counterweight includes adjusting the counterweight position to dampen windmill support oscillations.

In step 308, the windmill assembly operates a wind speed sensor to sense wind speed in the vicinity of the windmill support tower, and then in step 310, the windmill assembly adjusts the position of the windmill counterweight in response to a signal from said wind speed sensor to adjust the position of the movable counterweight to at least partially compensate for the force on the support tower due to the wind.

In some embodiments the counterweight is a slidable weight and adjusting the position of the windmill counterweight includes sliding said counterweight, e.g., on a counterweight shaft. In various embodiments, the counterweight is a liquid and adjusting the position of the windmill counterweight includes pumping at least some of said liquid from one location to another. In various embodiments, the counterweight is a multi-part weight. For example, the counterweight may include a plurality of fixed weights and at least one of said plurality of fixed weight may be repositioned without changing the position of at least one other of said plurality of fixed weights. For example, a first repositionable counterweight may be associated with a wind sensor measurement, and a second repositionable counterweight may be associated with a tower motion sensor measurements. As another example, the counterweight may include a first portion which is a fixed solid mass, e.g., a slidable counterweight, and a second portion which is a liquid counterweight. For example, the liquid counterweight portion may be used primarily for a steady state balance level, and the slidable fixed solid mass may be moved to respond to dampen tower oscillations. Different time constants may be associated with the control loops of the two different portions.

In various embodiments, adjusting the position of the windmill counterweight includes operating a computer module to generate a counterweight position control signal as a function of said at least one sensor. In various embodiments, adjusting the position of the windmill counterweight includes operating a computer module to generate a counterweight position control signal as a function of said at wind speed sensor signal. The computer module, in some embodiments, includes and uses stored oscillation model information, e.g., modeling information relating sensor detected tower oscillation levels and/or profiles to counterweight repositioning control information and/or stored steady state balance model information, e.g., modeling information relating steady state wind speed levels to counterweight repositioning control information.

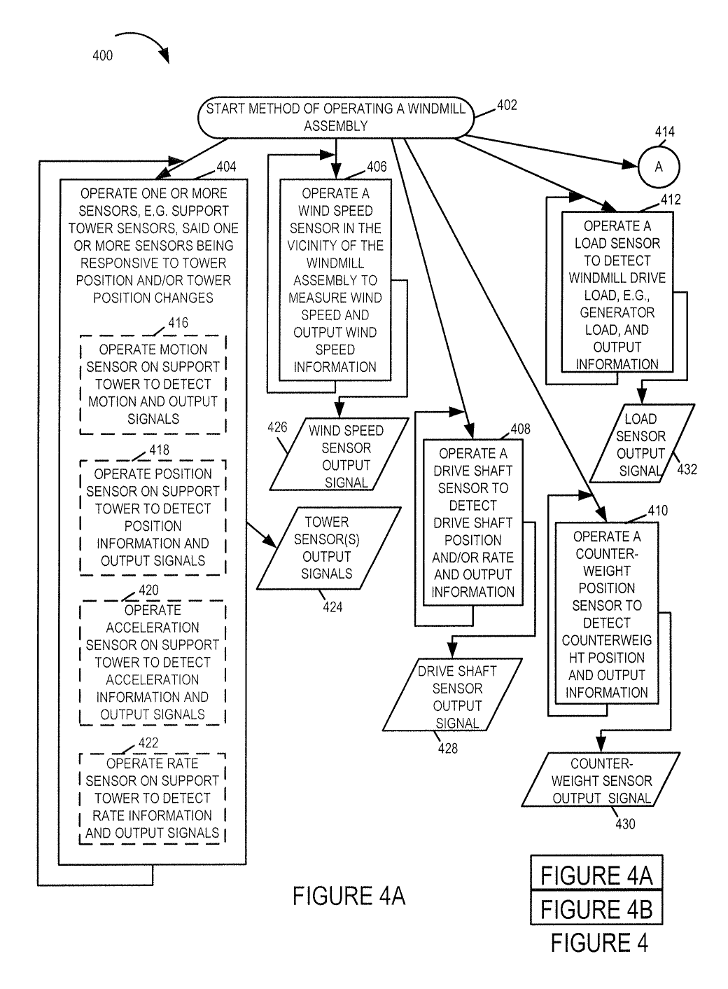

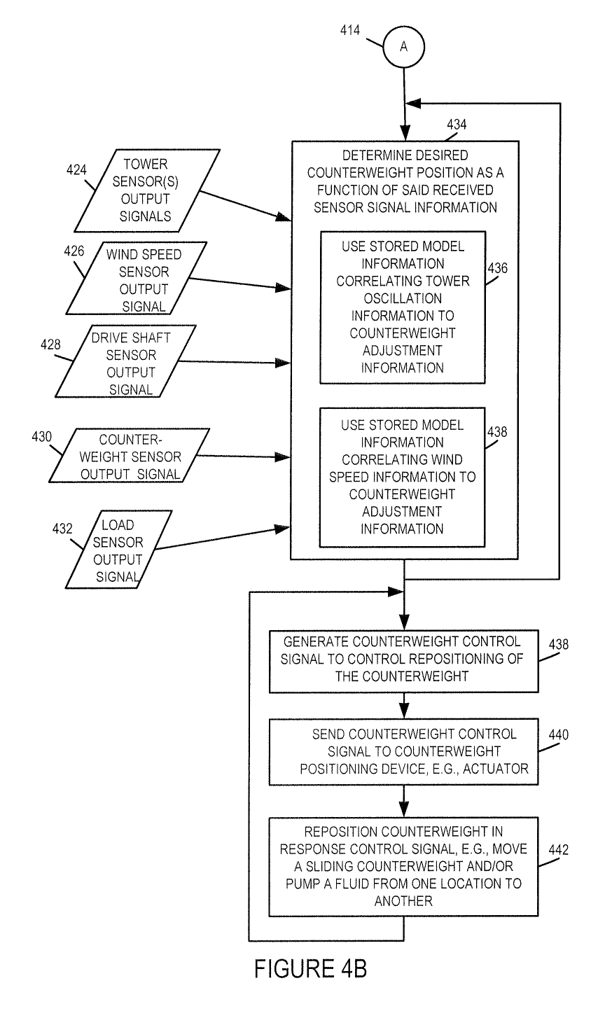

FIG. 4 is a drawing of a flowchart 400 of an exemplary method of operating a windmill assembly in accordance with various embodiments of the present invention. The windmill assembly may be exemplary windmill assembly 102 of FIG. 1. A computer control module included as part of the windmill assembly may be used for implementing at least some of the steps of the method of flowchart 400. Operation starts in step 402 where the windmill assembly is powered on and initialized. Operation proceeds from start step 402 to steps 404, 406, 408, 410, 412, and 432 via connecting node A 414.

In step 404, which is performed on a recurring basis, the windmill assembly operates one or support tower sensors of the windmill assembly, the said one or more sensors being responsive to tower position and/or tower position changes. Tower sensor(s) output signals 424 is an output of step 404 and is used as an input in step 434.

In some embodiments, at least some or the support tower sensor are mounted on the support tower, e.g., an accelerometer, gyroscope, and/or other inertial measurement instrument attached to the tower. In some embodiments, at least a portion of a support tower sensor assembly is not attached to the tower but is used in detecting tower position and/or tower position changes. For example, a tower position sensor assembly may include a laser beam source and one or more light and/or heat sensitive detection devices, and at least one of the laser beam source and said one or more light and/or heat sensitive detection devices is not located on the tower, e.g., it is located on at a stable site in the vicinity of the tower and is not impacted by wind velocity and/or tower vibration, while the other one of the laser beam source and said light assembly is located on the tower.

Step 404 includes one or more of sub-steps 416, 418, 420 and 422. In sub-step 416, the windmill assembly operates a motion sensor, e.g., vibration sensor, shock sensor, sway sensor, oscillatory motion sensor, mercury switch sensor, etc., on the support tower to detect motion and output signals. In sub-step 418, the windmill assembly operates a position sensor, e.g., an encoder, a resolver, a synchro, an optical sensor, a linear position sensor, a GPS module, etc., on the support tower to detect motion information and output signals. In sub-step 420, the windmill assembly operates an acceleration sensor, e.g., a set of accelerometers on the support tower used to detect acceleration information and output signals, said signals including acceleration information and/or information derived from the measurements, e.g., velocity information and/or position information. In sub-step 422, the windmill assembly operates a rate sensor, e.g., a rate gyroscope, on the support tower to detect rate information and output signals.

In step 406, which is performed on a recurring basis, the windmill assembly operates a wind speed sensor in the vicinity of the windmill assembly to measure wind speed and output wind speed information. Wind speed sensor output signal 426 is an output of step 406 and is used as input in step 434. In some embodiments wind direction is also measured and utilized in step 434.

In step 408, which is performed on a recurring basis, the windmill assembly operates a drive shaft sensor to detect drive shaft position and/or rate and output information. Drive shaft sensor output signal 428 is an output of step 408 and an input to step 424. Drive shaft sensor position and/or rate can be useful in determining when a turbine blade will align with the tower and turbine rate of rotation, useful information when attempting to compensate for tower oscillations due to air turbulence and/or vibration balance considerations.

In step 410, the windmill assembly operates a counterweight position sensor to detect counterweight position and output information. Counterweight sensor output signal 430 is an output of step 410 and used in step 434 as input. The counterweight position information is advantageous in a closed loop control implementation of the counterweight repositioning.

In step 412, which is performed on a recurring basis, the windmill assembly operates a load sensor to detect windmill drive load, e.g., generator load, and output information. Load sensor output signal 432 is an output of step 412 and used as input in step 434. Different generator loads on the windmill can cause different motion responses at the tower, and such information may be useful in controlling tower motion and/or stresses.

In step 434, which is performed on a recurring basis, the windmill assembly determines a desired counterweight position as a function of the received sensor information (424, 426, 428, 430, 432). Step 434 includes sub-steps 436 and 438. In sub-step 436, the windmill assembly uses stored model information correlating tower oscillation information to counterweight adjustment information, while in sub-step 438, the windmill assembly uses stored model information correlation wind speed information, e.g., steady state wind speed information, to counterweight adjustment information. In some embodiments sub-step 436 includes determining oscillatory counterweight positioning control information including at least two of an amplitude value, a frequency value and a phase value.

Operation proceeds from step 434 to step 438, in which the windmill assembly generates a counterweight control signal to control repositioning of the counterweight. Then, in step 440, the windmill assembly sends the generated counterweight control signal to a counterweight positioning device, e.g., an actuator. Operation proceeds from step 440 to step 442, where the windmill assembly repositions the counterweight in response to a control signal, e.g., moving a sliding counterweight and/or pumping fluid from one location to another. Steps 438, 440 and 442 are performed on a recurring basis, e.g. with one iteration being performed in response to an output from step 434.

In various embodiments elements described herein are implemented using one or more modules to perform the steps corresponding to one or more methods of the present invention. Thus, in some embodiments various features of the present invention are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to a machine-readable medium including machine executable instructions for causing a machine, e.g., processor and associated hardware which may be part of a test device, to perform one or more of the steps of the above-described method(s).

Numerous additional variations on the methods and apparatus of the present invention described above will be apparent to those skilled in the art in view of the above description of the invention. Such variations are to be considered within the scope of the invention.

What is claimed is:

1. A windmill assembly, comprising:
a blade assembly;
a drive shaft coupled to said blade assembly;
a main driveshaft housing for housing at least a portion of said drive shaft;
a support tower for supporting said main drive shaft housing; and
a movable counterweight.

2. The windmill assembly of claim 1, further comprising:
a counterweight position adjuster for adjusting the position of the counterweight in response to a control signal at least one of a position sensor; and
a motion sensor mounted on said support tower.

3. The windmill assembly of claim 2, further comprising:
a computer control module coupled to said at least one sensor and said counterweight position adjuster for receiving sensor signals and for generating a counterweight position control signal as a function of at least one received sensor signal.

4. The windmill assembly of claim 3, wherein said computer control module generates said counterweight position control signal to adjust the position of said movable counterweight to dampen tower oscillations detected by said at least one sensor.

5. The windmill assembly of claim 4, further comprising:
a wind speed sensor having an output coupled to said computer control module, said computer control module being responsive to a wind speed signal received from said wind speed sensor when generating said counterweight position control signal.

6. The windmill assembly of claim 5, wherein said computer control module generates said counterweight position control signal to adjust the position of said movable counterweight to at least partially compensate for force on said support tower due to said wind.

7. The windmill assembly of claim 1, further comprising:
a wind speed sensor having an output coupled to said computer control module, said computer control module being responsive to a wind speed signal received from said wind speed sensor when generating said counterweight position control signal.

8. The windmill assembly of claim 2, wherein said computer control module generates said counterweight position control signal to adjust the position of said movable counterweight to at least partially compensate for force on said support tower due to said wind.

9. The windmill assembly of claim 2,
wherein said counterweight is a slidable weight.

10. The windmill assembly of claim 2, wherein said counterweight is a hydraulic fluid.

11. The windmill of claim 2, wherein said counterweight is a multipart weight.

12. The windmill of claim 3, wherein said computer control module includes at least one of:
stored oscillation model information; and
stored steady state balance model information.

13. A method of operating a windmill assembly, the method comprising:
operating at least one sensor to sense a position of a windmill support tower or motion of the windmill support tower; and
adjusting the position of a windmill counterweight in response to a signal from said at least one sensor.

14. The method of claim 13, wherein adjusting the position of the windmill counterweight includes adjusting the counterweight position to dampen windmill support tower oscillations.

15. The method of claim 13, further comprising:
operating a wind speed sensor to sense wind speed in the vicinity of said windmill support tower; and
adjusting the position of the windmill counterweight in response to a signal from said wind speed sensor to adjust the position of said movable counterweight to at least partially compensate for force on said support tower due to said wind.

16. The method of claim 14,
wherein said weight is a slidable weight; and
wherein adjusting the position of the windmill counterweight includes sliding said counterweight.

17. The method of claim 14,
wherein said weight is a liquid; and
wherein adjusting the position of the windmill counterweight includes pumping at least some of said liquid from one location to another.

18. The method of claim 14, wherein said windmill counterweight is a multipart weight.

19. The method of claim 14, wherein adjusting the position of the windmill counterweight includes operating a computer module to generate a counterweight position control signal as a function of said signal from said at least one sensor.

20. A method of operating a windmill assembly, the method comprising:
operating a wind speed sensor to sense wind speed in the vicinity of a windmill support tower; and
adjusting the position of a windmill counterweight in response to a signal from said wind speed sensor to adjust the position of said movable counterweight to at least partially compensate for force on said support tower due to said wind.

21. The method of claim 20,
wherein said counterweight is a slidable weight; and
wherein adjusting the position of the windmill counterweight includes sliding said counterweight.

22. The method of claim 21,
wherein said weight is a liquid; and
wherein adjusting the position of the windmill counterweight includes pumping at least some of said liquid from one location to another.
